(19) United States
(12) Patent Application Publication
(10) Pub. No.: US 2025/0084581 A1
(43) Pub. Date: Mar. 13, 2025

(54) MICROPLASTIC FILTERING SYSTEM FOR A HOUSEHOLD APPLIANCE, IN PARTICULAR A WASHING MACHINE, SUCH AS A LAUNDRY WASHING MACHINE, SAID SYSTEM BEING PROVIDED WITH A DRAINING PUMP

(71) Applicant: ELBI INTERNATIONAL S.P.A, Torino (IT)

(72) Inventors: Marco BECCHIO, Carignano (TO) (IT); Gianluca BENEDETTO, Torino (IT); Luca GARETTO, Torino (IT); Luca MAIORANA, Torino (IT)

(21) Appl. No.: 18/824,467

(22) Filed: Sep. 4, 2024

(30) Foreign Application Priority Data
Sep. 4, 2023 (IT) 102023000018114

(51) Int. Cl. D06F 39/10; B01D 29/11; B01D 29/64; B01D 35/16; B01D 35/26

(52) U.S. Cl. CPC D06F 39/10; B01D 29/117; B01D 29/6476; B01D 35/16; B01D 35/26; B01D 2201/325; B01D 2201/58

(57) ABSTRACT

The system (10) comprises a casing (12) internally defining a cavity (14) and comprising, in turn, an inlet (16) configured to receive a fluid that contains microplastics and leading into the cavity (14), and an outlet (18) configured to deliver the fluid contained in the cavity (14), from which the microplastics have been substantially removed. A filtering assembly (100) contained in the cavity (14) is configured to be crossed by the fluid entering the casing (12) through the inlet (16) and exiting through the outlet (18), thus internally trapping the microplastics. A compacting assembly (200) is situated in the cavity (14) and configured for collecting and compacting the microplastics trapped by the filtering assembly (100). A driving assembly (300) is configured to drive the compacting assembly (200). A storing container (20) is housed in a storing chamber (14c) defined by the cavity (14) and facing towards the compacting assembly (200), and is configured to store the microplastics collected and compacted by the compacting assembly (200). A draining pump (400) is configured for taking in the liquid contained in the storing chamber (14c) and pushing the liquid out of the casing (12).

This application claims benefit of Italian Patent Application No. 102023000018114, filed Sep. 4, 2023, which application is incorporated herein by reference. To the extent appropriate, a claim of priority is made to the above-disclosed application.

### TECHNICAL FIELD

The present invention relates to a microplastic filtering system for a household appliance, in particular a washing machine, such as a laundry washing machine.

### TECHNICAL BACKGROUND

Microplastic filtering systems for household appliances, in particular for washing machines, such as laundry washing machines, are known in the art.

In recent years, the use of synthetic fabrics has increased, resulting in larger amounts s of micrometric synthetic microfibres contained in wastewater and hence in the environment, leading to more environmental pollution. In particular, when synthetic fabrics are washed, synthetic microfibres are produced/released which are not biodegradable, thus causing increased water pollution from microplastics (this term refers to particles and/or fibres less than 5 mm in length).

Patent publication EP 4 148 178 A1 by the present Applicant describes a microplastic filtering system specifically intended for use in a laundry washing machine. The system can filter microplastics contained in the washing liquid, which is then drained from the washing tub. Although such system is particularly advantageous and effective in comparison with those previously known in the art, it is nonetheless desirable to add thereto some improvements and refinements.

One drawback of the system disclosed by patent publication EP 4 148 178 A1 lies in the fact that, in such a system, liquid tends to accumulate in the storing container which is intended to contain microplastics. This implies the risk that the storing container might become full too soon, thus preventing the compacting assembly from operating correctly and reducing, therefore, the effectiveness of the filtering assembly.

### SUMMARY OF THE INVENTION

It is one object of the present invention to provide a microplastic filtering system for a household appliance, in particular for a washing machine, such as a laundry washing machine, wherein such system can remedy one or more drawbacks of the prior art.

In particular, compared with the prior art, the system made in accordance with the present invention can solve the technical problem of improving the filtering effectiveness. In this regard, the action of the draining pump, which is configured for taking in the liquid from the storing chamber where the storing container is housed, improves the action of the compacting assembly, since any stagnating liquid is drained from the storing container. This results in increased effectiveness of the filtering assembly.

According to the present invention, this and other objects are achieved through a system having the technical features set out in the appended independent claim.

It is understood that the appended claims are an integral part of the technical teachings provided in the following detailed description of the present invention. In particular, the appended dependent claims define some preferred embodiments of the present invention that include some optional technical features.

Further features and advantages of the present invention will become apparent in light of the following detailed description, provided herein merely as a non-limiting example and referring, in particular, to the annexed drawings as summarized below.

### BRIEF DESCRIPTION OF THE DRAWINGS

FIG. 1 is a schematic block view representing a household appliance, in particular a washing machine, such as a laundry washing machine, in which a filtering system made in accordance with an illustrative embodiment of the present invention has been installed.

FIG. 2 is a two-dimensional axial sectional view of the system shown in FIG. 1.

FIG. 3 is an exploded perspective view of the system shown in the preceding Figures.

For completeness' sake, the following is a list of alphanumerical references and names used herein to identify parts, elements and components illustrated in the above-summarized drawings.
WM. Laundry washing machine
c. Cabinet
T. Washing Tub
D. Discharge piping
D1. Initial duct
D2. Terminal duct
WS. Waste system
DP. Discharge pump
PF. Discharge pump filter
L. Stagnating liquid
RD. Return duct
x-x. Longitudinal axis
10. Filtering system
12. Casing
14. Cavity
14a. Central chamber
14b. Peripheral chamber
14c. Storing chamber
16. Inlet
18. Outlet
20. Storing container
21. Clamping ring
22. Tubular portion
24. Cover member
26. Closure member
28. Draining duct
29. Spacer
30. Sealing gaskets
100. Filtering assembly
102. Hollow filtering body
104. Axial through aperture
106. Support shell
108. Lateral slots
200. Compacting assembly
202. Endless screw
204. Helicoidal profile
300. Driving assembly
302. Electric motor
303. Reduction gear train
304. Shaft
400. Draining pump
402. Rotor
404. Tube
406. Inlet opening
408. Outlet opening
410. Elbow connection

### DETAILED DESCRIPTION OF THE INVENTION

With reference to the annexed drawings, numeral 10 designates as a whole a microplastic filtering system made in accordance with an illustrative embodiment of the present invention. System 10 is applicable to a household appliance, in particular to a washing machine. The term “microplastics” refers to particles and/or fibres of synthetic or plastic material which are less than 5 mm in length, and which, in particular, may also have micrometric dimensions.

In the embodiment illustrated herein, system 10 will be described with particular reference to a laundry washing machine WM.

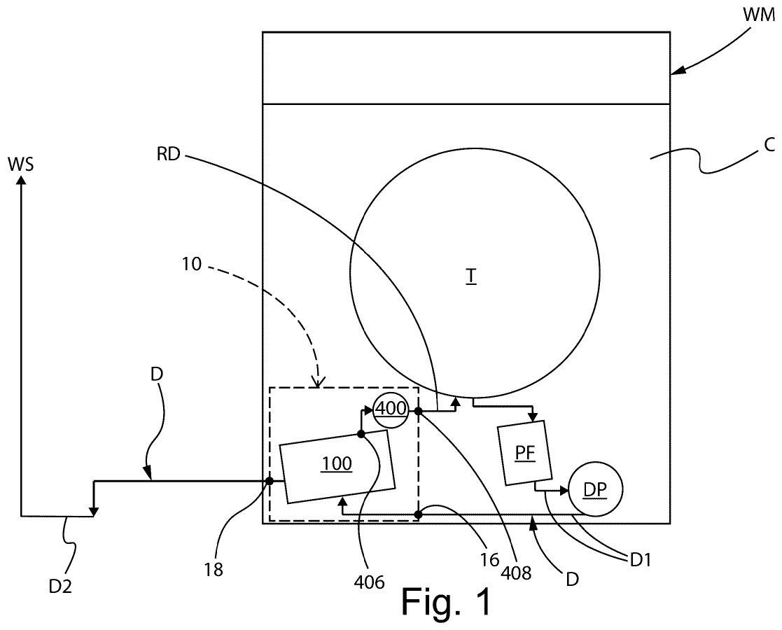

With particular reference to FIG. 1, laundry washing machine WM comprises a cabinet C in which a washing tub T is defined, which is sealed from the outside environment by a door (not shown). Laundry washing machine WM comprises also, in a per se known manner, a basket (not shown) rotatably mounted in washing tub T.

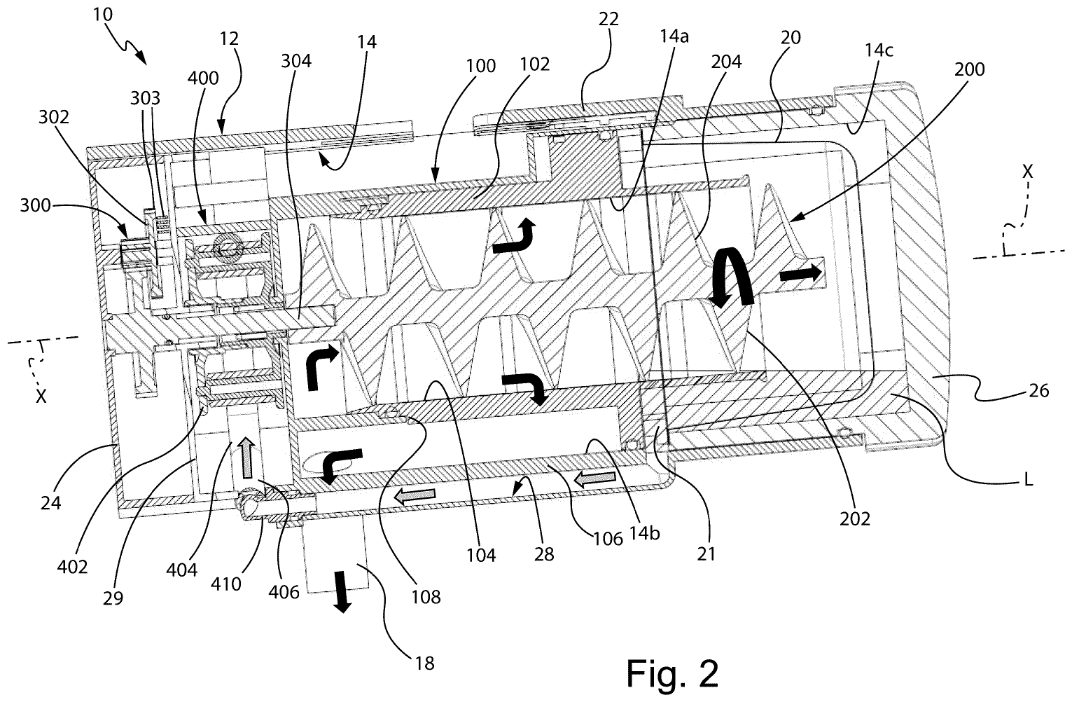

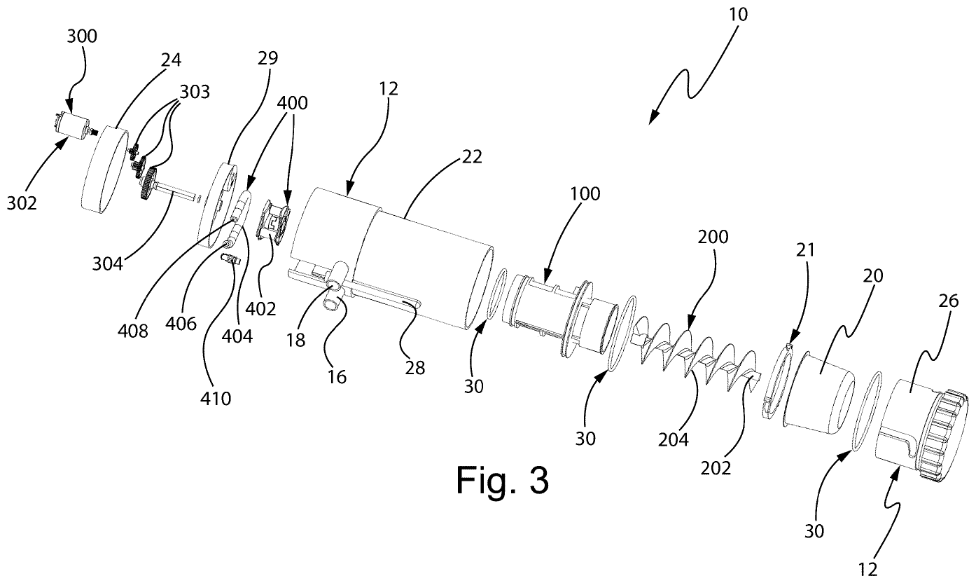

As will be further described below also with reference to FIGS. 2 and 3, system 10 comprises a casing 12 internally defining a cavity 14 (details thereof are visible in FIG. 2). Casing 12 has a substantially tubular shape and develops along a longitudinal axis X-X.

In the embodiment described herein, terms or expressions such as “axial” or “axially”, “transversal” or “transversally”, “radial” or “radially”, “lateral” or “laterally”, “internal” or “internally”, “external” or “externally”, “annular” or “annularly”, “peripheral” or “peripherally” are meant to refer to longitudinal axis X-X.

Furthermore, casing 12 comprises an inlet 16 configured to receive a fluid that contains microplastics and leading into cavity 14. Casing 12 comprises also an outlet 18 configured to deliver the fluid contained in cavity 14, from which microplastics have been substantially removed. In the embodiment shown in FIG. 1, system 10 is fluidically mounted to a discharge piping, designated as a whole as D, of laundry washing machine WM. Discharge piping D is fluidically connected to washing tub T on one side and connectable to a waste system WS on the other side. In particular, discharge piping D comprises an initial duct D1 fluidically connected to washing tub T on one side and to inlet 16 of system 10 on the other side; discharge piping D comprises also a terminal duct D2, in turn fluidically connected to outlet 18 of system 10 and fluidically connectable to the waste system. Therefore, the “dirty” washing liquid, which contains microplastics, coming from washing tub T flows in initial duct D1, while the “filtered” washing liquid, substantially free from such microplastics, flows in terminal duct D2.

Furthermore, in the embodiment illustrated herein, washing machine WM comprises a discharge pump DP situated in initial duct D1 and fluidically connected downstream of washing tub T and upstream of inlet 16 of system 10. Discharge pump DP is configured to push the washing liquid, containing microplastics and coming from washing tub T, towards inlet 16 of system 10. Washing machine WM comprises also a discharge pump filter PF situated in initial duct D1 and fluidically connected downstream of washing tub T and upstream of discharge pump DP. Discharge pump filter PF is configured to filter the washing liquid, containing microplastic and coming from washing tub T, before it enters discharge pump DP. Therefore, discharge pump filter PF and discharge pump DP are fluidically connected in series in initial duct D1.

In the embodiment illustrated herein, casing 12 comprises a tubular portion 22, a cover member 24 and a closure member 26 sealingly connected to tubular portion 22 on opposite sides, thereby internally defining cavity 14. In particular, cavity 14 is laterally delimited by tubular portion 22 and axially delimited, on opposite sides, by cover member 24 and closure member 26. Tubular portion 22 develops around longitudinal axis X-X.

As will be described in more detail below, inlet 16 and outlet 18 lead into chamber 14 through casing 12 in a substantially transversal direction (i.e. substantially perpendicular to longitudinal axis X-X). In the embodiment illustrated herein, inlet 16 and outlet 18 are formed laterally on casing 12, i.e. with axes oriented transversally to longitudinal axis X-X. In more detail, inlet 16 and outlet 18 are formed on tubular portion 22. In the embodiment illustrated herein, inlet 16 and outlet 18 are provided as fittings laterally protruding from casing 12, in particular from tubular portion 22.

System 10 further comprises a filtering assembly 100 contained in cavity 14. Filtering assembly 100 is configured to be crossed by the fluid entering casing 12 through inlet 16 and exiting through outlet 18, thus internally trapping the microplastics contained in said fluid. In particular, filtering assembly 100 is, in a per se known manner, configured for trapping particles and/or fibres of synthetic or plastic material less than 5 mm in length, which may also, in particular, have micrometric dimensions.

System 10 comprises also a compacting assembly 200 situated in cavity 14 and configured for collecting and compacting the microparticles trapped by filtering assembly 100.

In addition, system 10 comprises a driving assembly 300 configured to drive compacting assembly 200. Preferably, driving assembly 300 comprises a motor, in particular an electric motor 302. In the illustrated embodiment, electric motor 302 co-operates with a reduction gear train 303 to drive compacting assembly 200. In particular, driving assembly 300 is housed in cover member 24.

Preferably, filtering assembly 100 comprises a hollow filtering body 102 having an axial through aperture 104. Hollow filtering body 102 comprises, advantageously, a plurality of concentrical cylindrical filtering layers of different mesh gauges suitable for trapping microplastic particles of different sizes. In the embodiment illustrated herein, filtering assembly 100 comprises a support shell 106, in which hollow filtering body 102 is mounted. In addition, support shell 106 has a plurality of lateral apertures or slots 108 (only one of which is numbered in FIG. 2) forming a “cage” that laterally supports hollow filtering body 102 and allows fluid to flow therethrough. In the embodiment illustrated herein, filtering assembly 100 is removable from casing 12.

Preferably, as will be described hereafter, compacting assembly 200 extends axially through filtering assembly 100. In particular, axial through aperture 104 of hollow filtering body 102 is crossed by compacting assembly 200.

In the embodiment illustrated herein, compacting assembly 200 is configured to remove microplastics from the inner surface of hollow filtering body 102, in particular conveying them out of filtering assembly 100. In other words, compacting assembly 200 is operatively mounted in contact with the inner lateral surface of hollow filtering body 102, defined by axial through aperture 104, for removing microplastics from the filtering assembly. In this manner, compacting assembly 200 is configured to operatively slide against said inner lateral surface of hollow filtering body 102, thereby removing microplastics from such surface.

In the illustrated embodiment, compacting assembly 200 comprises an endless screw 202 configured to be rotatably driven by driving assembly 300, so as to axially push the solid particles trapped by filtering assembly 100.

In addition, endless screw 202 is housed in axial through aperture 104 of hollow body 102, and is substantially aligned axially with longitudinal axis X-X.

In particular, endless screw 202 has a helicoidal profile 204 that, in a per se known manner, facilitates the conveyance of microplastics out of filtering assembly 100. In other words, helicoidal profile 204 is operatively mounted in contact with the inner lateral surface of hollow filtering body 102. In this way, helicoidal profile 204—rotatably driven by driving assembly 300—can effectively remove the microplastics deposited on said surface of hollow filtering body 102. In fact, helicoidal profile 204 is configured to rotatably slide against said surface of hollow filtering body 100, thereby removing microplastics therefrom.

As clearly visible in FIG. 2, cavity 14 is divided into a plurality of chambers 14a, 14b, 14c, in particular by inner walls of casing 12 and/or outer walls of filtering assembly 100, in particular of support shell 106. There is a central chamber 14a, laterally and axially delimited within filtering assembly 100, into which inlet 16 directly leads; central chamber 14a is axially crossed by compacting assembly 200 (in particular, by endless screw 202). In particular, central chamber 14a is also delimited laterally within hollow filtering body 102 and axially by an axial end of support shell 106. There is also a peripheral chamber 14b situated around central chamber 14a and bordering thereon via the walls of hollow filtering body 102, while it is delimited axially by an axial end of support shell 106; outlet 18 extends from peripheral chamber. Lastly, there is a storing chamber 14c facing towards compacting assembly 12 (in particular, facing towards a free end of endless screw 202). In addition, storing chamber 14c is adjacent, in the axial direction, to central chamber 14a and in direct fluidic communication with such central chamber 14a; said storing chamber 14c is laterally and axially delimited by casing 12, in particular by closure member 26.

System 10 further comprises a storing container 20 situated in storing chamber 14c and facing towards compacting assembly 200. Storing container 20 is configured to receive the microplastics collected and compacted by compacting assembly 200. Particularly, storing container 20 is removable from cavity 14 and accessible through casing 12.

In the embodiment illustrated herein, storing container 20 is housed in closure member 26, which internally defines storing chamber 14c. In particular, storing container 20 is substantially cup-shaped, and closure member 26 is substantially glass-shaped. In particular, storing container 20 and closure member 26 are mutually assembled by means of a clamping ring 21, wherein a peripheral edge of storing container 20 is axially locked between clamping ring 21 and a corresponding peripheral edge of closure member 26. In addition, axial through aperture 104 of hollow body 102 faces towards storing container 20. Closure member 26 is mounted to tubular portion 22 and removable, in particular repeatably and reversibly, therefrom. For example, closure member 26 can be coupled to and, respectively, decoupled from tubular portion 22, so that a user can gain access to the inside of casing 12. Particularly, a bayonet mechanism or a threaded connection may be provided for removably coupling closure member 26 to tubular portion 22. Therefore, by removing closure member 26 from tubular portion 22 it is possible to remove and/or replace storing container 20 from casing 12 in order to empty it of the microplastics accumulated therein and compacted by compacting assembly 200.

System 10 further comprises a draining pump 400 configured for taking in liquid contained in storing chamber 14c and pushing such liquid out of casing 12. Thanks to such technical features, liquid L is prevented from stagnating in the storing container and interfering with the normal operation of compacting assembly 200, with the risk of clogging filtering assembly 100—particularly when system 10 is installed in laundry washing machine WM with longitudinal axis X-X oriented in a substantially horizontal direction (e.g. according to the arrangement shown in FIG. 2). This increases the general filtering effectiveness of system 10.

In the system arrangement shown in FIG. 1, longitudinal axis X-X is oriented in a substantially horizontal direction, with such an inclination that storing chamber 12c and storing container 20 are in a higher position than filtering assembly 100 and compacting assembly 200. This facilitates the outflow of the washing liquid from central chamber 14a towards peripheral chamber 14b.

Preferably, draining pump 400 is of the peristaltic type. In particular, draining pump 400 comprises, in a per se known manner, a rotor 402 and an elastically deformable tube 404, having an inlet opening 406 and an outlet opening 408 (only visible in FIG. 3). Rotor 402 is configured to co-operate with respective tube 404 to push stagnating liquid L contained in corresponding storing chamber 14c. Also, rotor 402 comprises a pair of projecting portions (not numbered), preferably situated on diametrically opposite sides, adapted to be placed in contact with the deformable walls of tube 404. In particular, such projecting portions are adapted to locally throttle tube 404 and cause the liquid contained in the latter to flow on during the rotation of rotor 402. Preferably, each one of the projecting portions comprises a peripheral roller adapted to locally press on tube 404 in order to throttle it.

In the embodiment illustrated herein, tube 404 is mounted in such a way that its outlet opening 408 leads out of system 10, particularly out of casing 12, so as to discharge in washing tub T any washing liquid L stagnating in storing chamber 14c. In particular, as shown in FIG. 1, laundry washing machine WM comprises a return duct RD hydraulically connected to outlet opening 408 on one side and to an inlet of washing tub T on the other side.

Preferably, casing 12 defines a draining duct 28 fluidically connected to storing chamber 14c on one side and to the inlet of draining pump 400 on the other side-in particular, to inlet opening 406. In the embodiment illustrated herein, the hydraulic connection of draining duct 28 is provided by means of an elbow connection 410 hydraulically connected to inlet opening 406 on one side and to one end of draining duct 28 on the other side.

Preferably, draining duct 28 is defined on the periphery of casing 12 (e.g. of the latter's tubular portion 22).

In the embodiment illustrated herein, draining duct 28 extends along casing 12 (in particular, along tubular portion 22) in a substantially axial direction.

In the embodiment illustrated herein, draining duct 28 is defined by an interspace laterally delimited between casing 12 (in particular, the latter's tubular portion 22) and filtering assembly 100 (in particular, the latter's support shell 106).

Preferably, draining pump 400 is supported between casing 12 (in particular, cover member 24) and filtering assembly 100 (in particular, an axial end of support shell 106). In addition, electric motor 302 and reduction gear train 303 are sealingly separated from draining pump 400 through the interposition of a spacer 29.

Driving assembly 300 comprises a shaft 304 configured to be rotatably driven by electric motor 302, in particular via reduction gear train 303, for controlling compacting assembly 200. In particular, shaft 304 extends in cavity 14 in order to co-operate with compacting assembly 200. In the illustrated embodiment, shaft 304 is coupled to endless screw 202 to control the rotation thereof, such two parts being, in particular, rotatably integral (e.g. keyed with each other). In more detail, shaft 304 and endless screw 202 are substantially coaxial to each other and to longitudinal axis x-x.

Preferably, driving assembly 300 is also configured to control draining pump 400. Thus, when system 10 is in operation, driving assembly 300 provides not only the action of compacting the microplastics towards storing container 20, but also the action of draining any liquid stagnating in storing chamber 14c.

In the embodiment illustrated herein, shaft 304 is controllable in rotation and mounted coaxial to both rotor 402 and endless screw 202. In particular, shaft 304 is rotatably supported by casing 12 (in particular, by cover member 24 and/or spacer 29) on one side and, on the axially opposite side, by filtering assembly 100 (in particular, by support shell 106, e.g. by the top thereof). Particularly, shaft 304 axially and sealingly crosses spacer 29 to connect to rotor 402 and endless screw 202.

By way of example, fluid-tightness of casing 12 is obtained by means of a plurality of sealing gaskets 30 interposed between members 24 and 26 and tubular portion 22. In particular, sealing gaskets 30 have a substantially annular shape, e.g. they are O-rings.

For completeness' sake, the following will briefly describe the path followed by the washing liquid in system 10, from washing tub T to waste system WS.

When system 10 is in operation, inlet 16, which is hydraulically connected to initial duct D1 of discharge piping D, is configured to receive, substantially in a transversal or radial direction, the microplastic-containing washing liquid delivered by pump DP. Subsequently, inlet 16 extends transversally or radially through tubular portion 22 of casing 12 and leads into central chamber 14a defined in filtering assembly 100 by hollow filtering body 102.

Central chamber 14a receives the microplastic-containing washing liquid and hydraulically communicates, transversally or radially, with peripheral chamber 14b through the sidewalls of hollow filtering body 102. In particular, in the substantially horizontal arrangement of system 10 shown in FIG. 2, the washing liquid flows from central chamber 14a to peripheral chamber 14b also by gravity, since peripheral chamber 14b is underneath. Therefore, central chamber 14a retains the microplastics within hollow filtering body 102, so that peripheral chamber 14b receives washing liquid which is substantially free from microplastics.

At the same time, central chamber 14a hydraulically communicates, in the axial direction, with storing chamber 14c, which, due to the action of compacting assembly 200, receives the microplastics retained within the hollow filtering body, and traps them in the storing container 20.

Subsequently, the washing liquid, from which microplastics have been substantially removed, flows out of peripheral chamber 14b, transversally or radially, through outlet 18 to exit tubular portion 22 of casing 12. Outlet 18 is connected to terminal duct D2 of discharge piping D, thus delivering to waste system WS washing liquid which is substantially free from microplastics.

Of course, without prejudice to the principle of the invention, the forms of embodiment and the implementation details may be extensively varied from those described and illustrated herein by way of non-limiting example, without however departing from the scope of the invention as set out in the appended claims.

1. A microplastic filtering system for a household appliance; said system comprising:
a casing internally defining a cavity and comprising:
an inlet configured to receive a fluid that contains microplastics and leading into the cavity, and
an outlet configured to deliver said fluid contained in said cavity, from which said microplastics have been substantially removed;
a filtering assembly contained in the cavity and configured to be crossed by the fluid entering said casing through the inlet and exiting through said outlet, to internally trap said microplastics;
a compacting assembly situated in said cavity and configured for collecting and compacting the microplastics trapped by the filtering assembly;
a storing container housed in a storing chamber defined by the cavity and facing towards said compacting assembly, and configured to store the microplastics collected and compacted by said compacting assembly;
a draining pump configured for taking in liquid contained in said storing chamber and pushing said liquid out of said casing.

2. The system according to claim 1, wherein said draining pump comprises a peristaltic pump.

3. The system according to claim 1, wherein said casing defines a draining duct fluidically communicating with said storing chamber on one side and with an inlet of said draining pump on an other side.

4. The system according to claim 3, wherein the draining duct is defined on a periphery of said casing.

5. The system according to claim 3, wherein said draining duct extends along said casing in a substantially axial direction.

6. The system according to claim 3, wherein said draining duct is defined by an interspace laterally delimited between said casing and said filtering assembly.

7. The system according to claim 1, wherein said draining pump is supported between said casing and said filtering assembly.

8. The system according to claim 1, comprising a driving assembly configured to drive the compacting assembly.

9. The system according to claim 8, wherein said driving assembly is configured to drive said draining pump.

10. The system according to claim 9, wherein said driving assembly comprises a shaft controllable in rotation and mounted coaxial to both a rotor of said draining pump and an endless screw of said compacting assembly.

11. The system according to claim 1, wherein said storing container is removable from the cavity and accessible through the casing.

12. The system according to claim 1, wherein the household appliance comprises, a washing machine.
